(19) United States
(12) Patent Application Publication
(10) Pub. No.: US 2014/0189244 A1
(43) Pub. Date: Jul. 3, 2014

(54) SUPPRESSION OF REDUNDANT CACHE STATUS UPDATES

(71) Applicants: Brian C. Grayson, Austin, TX (US); David P. Burgess, Austin, TX (US); Peter J. Wilson, Leander, TX (US)

(72) Inventors: Brian C. Grayson, Austin, TX (US); David P. Burgess, Austin, TX (US); Peter J. Wilson, Leander, TX (US)

(21) Appl. No.: 13/732,533

(22) Filed: Jan. 2, 2013

(51) Int. Cl. G06F 12/08

(52) U.S. Cl. CPC G06F 12/0891; G06F 12/0864
USPC 711/128; 711/133; 711/136

(57) ABSTRACT

A cache management system employs a replacement policy in a manner that manages redundant accesses to cache elements. The cache management system comprises a cache, a replacement policy state storage and an update control module. The update control module comprises a buffer for storing recent addresses, a comparison unit for comparing a new address with those stored in the recent address buffer, and an update unit which determines whether to update the replacement policy state storage. When an address matches those stored in the recent address buffer, a replacement status update is suppressed.

### FIELD OF THE DISCLOSURE

This disclosure generally relates generally to cache memories, and more particularly, to maintenance of cache status information for replacement policies for cache memories.

### BACKGROUND

A cache memory system typically implements a replacement policy used in determining which entries of the cache should be removed in order to make space to bring in new entries. Typically, the cache memory system provides replacement status information for each cached element, and each access to a cache element causes an update to the replacement status associated with that cache element.

### BRIEF DESCRIPTION OF THE DRAWINGS

The present disclosure may be better understood, and its numerous features and advantages made apparent to those skilled in the art by referencing the accompanying drawings.

FIG. 1 illustrates a processing system having a cache management system employing selective suppression of replacement status updates in accordance with at least one embodiment of the present disclosure.

FIG. 2 illustrates a method of selective suppression of replacement status updates in a cache management system in accordance with at least one embodiment of the present disclosure.

### DETAILED DESCRIPTION

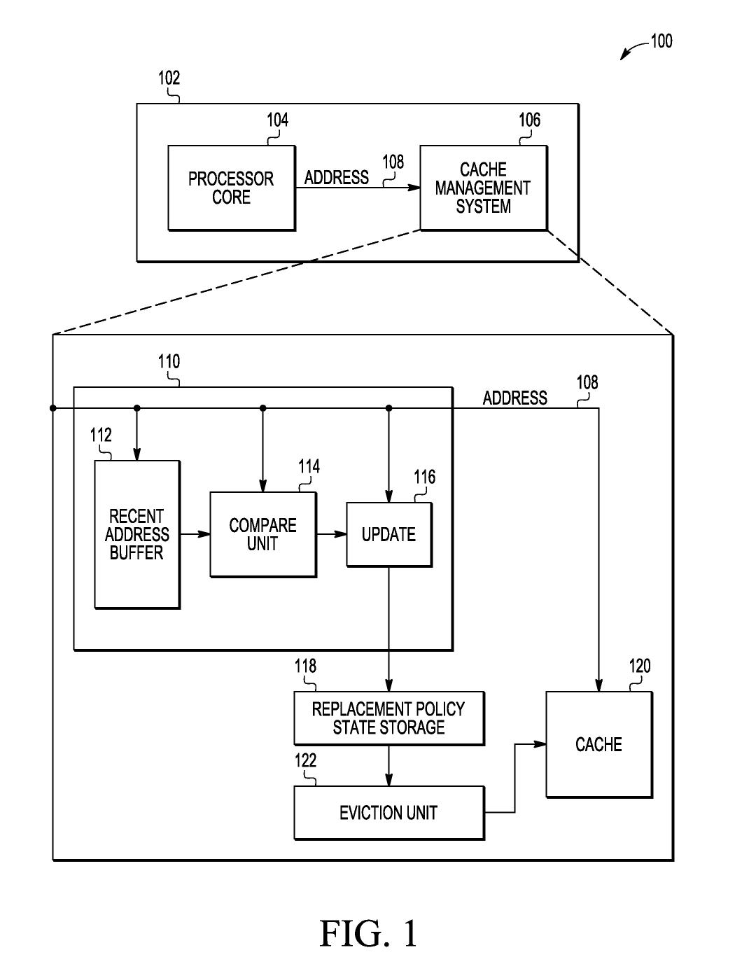

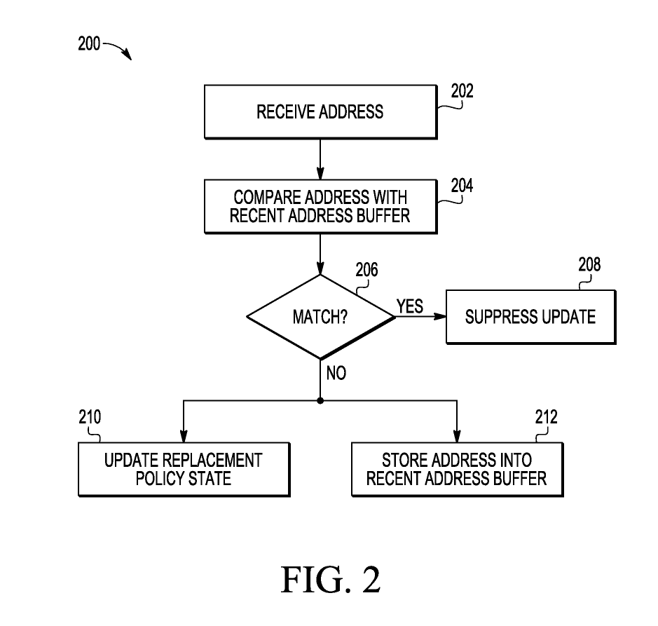

FIGS. 1 and 2 illustrate embodiments of a cache management system employing a replacement policy in a manner that manages redundant accesses to cache elements. The cache management system comprises: a cache; a replacement policy state storage to store state information used by the replacement policy; and an update control module. The replacement policy state storage may comprise a stand-alone array that includes storage elements such as those included in a register file, RAM array, or any other suitable memory structure. The update control module comprises a recent address buffer that stores a number of recent addresses, a comparison unit that compares an address of a cache access with those stored in the recent address buffer, and an update unit that determines whether to update the replacement policy state storage based on the comparison. The recent address buffer reflects a recent history of cache accesses, and thus reflects recent cache accesses that have had their replacement statuses recently updated. Typically for each cache access, a replacement status update is performed based on the employed replacement policy. When a cache access whose address matches an address stored in the recent address buffer occurs, a replacement status update was recently performed for the corresponding cache entry, and thus another replacement status update would be redundant. Accordingly, when such a match occurs, the update of the replacement status for the cache access is suppressed or otherwise inhibited, thereby avoiding the unnecessary replacement status update. Otherwise, when a match is not found, then the replacement policy state storage is updated and the new address is stored in the recent address buffer. By inhibiting redundant updates to the replacement policy state storage, the power consumption of the cache management system is significantly reduced.

FIG. 1 depicts a processing system 100 according to some embodiments of the present disclosure. The processing system 100 includes one or more processor cores 104 and a cache management system 106 employing a replacement policy for identifying cache elements for eviction. In some embodiments, the cache management system 106 can be implemented as an integrated circuit (IC) 102, for example, packaged together with, or separate from, the processor core(s) 104.

The cache management system 106 may be implemented as part of a larger memory hierarchy, which may include one or more levels of cache memory, one or more levels of system memory (e.g., system random access memory (RAM)), and one or more mass storage devices. In such memory hierarchies, data is typically accessed using unique addresses, whereby each data element maps to a corresponding unique memory address. As the memory address space may be relatively large, the processing system 100 may employ a virtual addressing scheme whereby the processor core 104 and other peripheral components (not shown) utilize virtual addresses, which are translated to physical addresses when accessing the memory hierarchy. Thus, the term “address,” as used herein, can include any of a variety of address types implementable in a processing system, including, but not limited to, a virtual address or a physical address.

In the depicted example, the cache management system 106 comprises an update control module 110, a replacement policy state storage 118, an eviction unit 122, and a cache 120. In some embodiments, the update control module 110 can be implemented in circuitry that is separate from the circuitry that includes the cache 120, the replacement policy state storage 118, and the eviction unit 122. The cache 120 caches data elements accessed from elsewhere in the memory hierarchy, whereby each cached data element is stored at a corresponding cache line of the cache 120. The replacement policy state storage 118 includes a plurality of entries, each entry corresponding to a cache line of the cache 120 and storing a replacement status of the cache line. The eviction unit 122 evicts an appropriate cache line based on the replacement status to make room for a new cache line entry. The replacement status can include an indication of age or freshness of the accesses to the cache 120, providing information to determine which cache line should be evicted by the eviction unit 122 when the cache is full. The replacement status can be represented by one or more stored bits in the replacement policy state storage. In some embodiments, the one or more bits stored to the replacement policy state storage 118 are sufficient to represent a status associated with a cache line that is useful in determining whether a cache line is to be evicted. In some embodiments, the replacement policy state storage 118 can be a portion or region of a cache tag memory traditionally associated with a cache. In some embodiments, the cache memory comprises a set associative or multi-way set associative cache memory.

The update control module 110 controls updates to the replacement policy state storage. Among other features, the update control module 110 includes a recent address buffer 112. The recent address buffer 112 should be sufficiently small in some embodiments, storing the addresses of the most recent cache accesses. In some embodiments, the recent address buffer 112 stores the addresses of the last four cache accesses. In some embodiments, the recent address buffer 112 stores the addresses of the last eight or less cache accesses. In some embodiments, the recent address buffer 112 stores the addresses of the last 16 or less cache accesses. In some embodiments, the recent address buffer 112 stores the addresses of at least 64 cache accesses. In some embodiments, the values stored to the recent address buffer 112 comprise virtual or relative addresses. In some embodiments, the values stored to the recent address buffer 112 comprise physical addresses. In some embodiments, the values stored to the recent address buffer 112 are sufficient to represent a cache line. In some embodiments, the address 108 is sufficient to compare to the recent address buffer and determine whether the address is within a cache line for each entry stored to the recent address buffer.

The update control module 110 also includes features such as a comparison unit 114 and an update unit 116. When accessing the cache 120, an address 108 associated with the access is received by the update control module 110. The comparison unit 114 within the update control module 110 compares the received address 108 with those stored in the recent address buffer 112. The comparison of the new address to the stored address need not use all of the bits of either address. If the address 108 matches any of the addresses stored in the recent address buffer 112, then a replacement status update was performed recently, and there is no need to redundantly update the state again for this access. The update unit 116 therefore inhibits or suppresses an update to the replacement policy state storage 118 for the associated cache access. If the address 108 does not match any of the addresses stored in the recent address buffer 112, then the replacement policy state storage 118 is updated and the address is stored in the recent address buffer 112.

Benchmark analysis has shown that in at least one embodiment of the present disclosure with a recent address buffer 112 having storage for four recent addresses, the update unit 116 inhibits or filters out on average more than 50% of all replacement status updates. Accordingly, the cache management system conserves power for each update inhibited or filtered out.

In some embodiments, the replacement policy scheme comprises a Pseudo-Least Recently Used (PLRU) scheme. Other replacement policy schemes may be employed in the cash management system including LRU or MRU for example. Embodiments of the present disclosure are not limited by any specific replacement policy scheme.

FIG. 2 illustrates an example method 200 for a cache management system in accordance with at least one embodiment of the present disclosure. For ease of illustration, the method 200 is described below in the example context of the cache management system 106 of the processing system 100 of FIG. 1.

At block 202, the processor core 104 initiates a cache access to the cache management system 106. With each cache access updates are stored in the replacement policy state storage that indicates the freshness or staleness of cache elements. As part of this initiated cache access, the processor core 104 supplies an address for the cache access. This address is distributed among components of the cache management system 106, such as the cache 120 and the update control module 110. The address of the cache access is also distributed among units within the update control module such as a recent address buffer, a comparison unit, and an update unit.

At block 204 in the update control module 110, the address of the cache access is compared with each of the addresses stored. The comparison unit 114 receives the address of the cache access and compares the received address with addresses stored in the recent address buffer 112. If the address of the cache access matches one of the addresses stored in the recent address buffer, then a replacement status update for the cache element represented by this address was recently performed. If the address of the cache access does not match one of the addresses stored in the recent address buffer, then a replacement status update for the cache element represented by this address was not performed recently enough to have its address within the recent address buffer. In this case, an update to the replacement policy status is needed along with an update of the recent address buffer with the address of the cache access.

At block 206, if the compare from the comparison unit indicates that the address of the cache access matches one of the addresses stored in the recent address buffer, then no further action is needed. In this case, a match indicates that a replacement status update was recently performed, and there is no need to update the replacement policy state storage for this access. If the compare from the comparison unit indicates that the address of the cache access does not match any of the addresses stored in the recent address buffer, then an update to the replacement status is needed. Also, when the compare from the comparison unit does not indicate a match, the address needs to be stored to the recent address buffer.

At block 208, when the compare from the comparison unit indicates that the address of the cache access matches one of the addresses stored in the recent address buffer 112, then the update to the replacement policy state storage is suppressed or inhibited. In general, updates to the replacement policy state storage for each cache access consumes a significant amount of power and suppressing updates. Reducing or eliminating updates for redundant accesses provides significant power savings.

At block 210, when the compare from the comparison unit indicates that the address of the cache access does not match any of the addresses in the recent address buffer 112, a replacement status update is necessary. Accordingly, the replacement status update is stored to the replacement policy state storage 118.

At block 212, also when the compare from the comparison unit indicates that the address of the cache access does not match any of the addresses in the recent address buffer 112, the address of the cache access can be stored to the recent address buffer 112.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

1. A device comprising:
a cache having a plurality of cache lines to store information entries;
a replacement policy state storage having a plurality of entries, each entry of the plurality storing a replacement status of a corresponding cache line; and
an update control module to selectively suppress updates to the replacement policy state storage for a cache access, said suppression based on most recent updates to the replacement policy state storage.

2. The device of claim 1, wherein the update control module comprises:
a buffer to store addresses of the most recent updates to the replacement policy state storage;
a comparison unit to determine whether an address of a cache access matches an address stored in the buffer; and
wherein the update control module is to:
suppress an update to the replacement policy state storage for a cache access responsive to the comparison unit determining the address of the cache access matches an address stored in the buffer.

3. The device of claim 2, wherein responsive to the comparison unit determining the address of the cache access does not match an address stored in the buffer, the update control module conducts an update to the replacement policy state storage for the cache access storing the address of the cache access to the buffer.

4. The device of claim 1, wherein the replacement policy state storage is used by a pseudo-least recently used (PLRU) replacement policy.

5. The device of claim 1, wherein the replacement policy state storage is used by a most recently used (MRU) replacement policy.

6. The device of claim 1, wherein the cache comprises a multi-way set associative cache.

7. The device of claim 1, wherein addresses of the most recent updates to the replacement policy state storage comprise addresses stored in the recent address buffer in a manner to represent a cache line.

8. The device of claim 7, wherein the comparison unit compares an access address with addresses representing cache lines stored in the recent address buffer.

9. A method, comprising:
receiving an access request to a cache, the access having an address, said cache having a replacement policy;
comparing the address of the cache access with the one or more addresses of recent cache access addresses; and
responsive to determining the address of the cache access does not match any of the one or more addresses:
updating a replacement policy state; and
storing the address of the cache access to the recent address buffer.

10. The method of claim 9, further comprising when the address of the cache access does match any of the one or more addresses, suppressing updating to the replacement policy state, and suppressing storing the address of the cache access in the recent address buffer.

11. The method of claim 9, wherein receiving an access to a cache, the access having an address comprises a physical address of the cache.

12. The method of claim 9, wherein receiving an access to a cache, the access having an address comprises a relative or virtual address of the cache.

13. The method of claim 9, wherein said cache having a replacement policy comprises a PLRU replacement policy scheme.

14. The method of claim 9, wherein the address of the cache access comprises an address of the cache access that represents a cache line.

15. The method of claim 9, wherein the one or more addresses are stored in a recent address buffer.

16. In a processing device, a method comprising:
buffering addresses associated with recent updates to a replacement policy state storage of a cache management system; and
suppressing an update to the replacement policy state storage for a first cache access responsive to determining an address of the first cache access matches a buffered address.

17. The method of claim 16, further comprising:
permitting an update to the replacement policy state storage for a second cache access responsive to determining an address of the second cache access does not match any of the buffered addresses.

18. The method of claim 17, further comprising:
buffering the address of the second cache access responsive to determining the address of the second cache access does not match any of the buffered addresses.

19. The method of claim 18, wherein buffering addresses associated with recent updates to a replacement policy state storage of a cache management system comprises buffering relative or virtual addresses associated with recent updates to the replacement policy state storage.

20. The method of claim 18, wherein buffering addresses associated with recent updates to a replacement policy state storage of a cache management system comprises buffering addresses that represents a cache line.
